(19) United States
(12) Patent Application Publication
(10) Pub. No.: US 2003/0103795 A1
(43) Pub. Date: Jun. 5, 2003

(54) Pressurized reservoir floor cleaning device

(75) Inventors: Anthony Scott Hollars, Tucson, AZ (US); Randall Scott Maddox, Green Valley, AZ (US)

Correspondence Address: Anthony S. Hollars, 6445 W. Lost Canyon Drive, Tucson, AZ, 85745, US

(73) Assignee: Innovative Products and Design, Inc., Tucson, AZ

(21) Appl. No.: 10/307,599

(22) Filed: Dec. 2, 2002

Related U.S. Application Data
(60) Provisional application No. 60/337,367, filed on Dec. 4, 2001.

(51) Int. Cl. B05C 17/005; A47L 13/26

(52) U.S. Cl. 401/138; 401/137; 401/190

(57) ABSTRACT

The present invention uses a pressurized fluid reservoir mounted on a mop to deliver cleaning solution on a floor. The liquid in the reservoir is dispensed at the user's discretion from a biased-closed spray nozzle downstream from the reservoir. Three different methods of creating a pressurized reservoir are: using a compressed gas cartridge either regulated or not, using a hand-actuated pump, and utilizing an aerosol can with a standard propellant of known vapor pressure. The aerosol can either is used strictly as a propellant creating pressure on a reservoir or the aerosol can contains a cleaning solution or the like as well as propellant all in one replaceable can.

### CROSS REFERENCE TO RELATED APPLICATIONS

Not Applicable.

### FEDERALLY SPONSORED RESEARCH

Not applicable.

### REFERENCE TO A MICROFICHE APPENDIX

Not applicable.

### FIELD OF THE INVENTION

This invention relates to a system for conveniently mopping a floor wherein a liquid reservoir is contained on a mop device and dispensable at the discretion of the user.

### BACKGROUND OF THE INVENTION

Originally, floor mops were dipped into a bucket of cleaning solution and then either wrung out by hand or pinched in a hand-actuated device to remove excess water. Through time, various designs of mops incorporated a built-in feature enabling the user to wring out water through some twisting motion or by actuation of a rocking lever integrated into the mop or similar. Both of the afore-mentioned methods of wetting a mop relied on a separate liquid reservoir such as using a bucket. The result has been the requirement of an additional step in mopping a floor, requiring additional time and the need to rinse out a bucket after the fact.

### SUMMARY OF THE INVENTION

The present invention has solved the problems cited above by incorporating everything needed for mopping a floor into one device. Broadly, this invention solves the problem of needing to dip a mop into a bucket and wringing out excess water prior to cleaning a floor. In general, a cleaning solution reservoir is located on the mop assembly. The solution is controllably released from the reservoir, through a spray nozzle, at the user's discretion, driven by a pressurized fluid reservoir. There are several methods of creating the reservoir pressure as are described in the detailed description.

### BRIEF DESCRIPTION OF THE DRAWINGS

FIG. 1 is a side view of a floor sprayer cleaning device showing a compressed gas cartridge regulated through a pressure regulator, pressurizing a fluid reservoir.

FIG. 2 is a side view of a floor sprayer cleaning device showing a hand-actuated pump fluidly connected to a fluid reservoir.

FIG. 3 is a side view of a floor sprayer cleaning device showing an aerosol propellant-type can providing pressure on a reservoir of fluid.

### DETAILED DESCRIPTION

This application claims the benefit of provisional patent application number 60/337,367 titled 37 Compressed Gas Cartridge Powered Liquid Sprayer for Floor Cleaning Device” filed Dec. 4, 2001 by Anthony Scott Hollars and Randall Scott Maddox.

Reference will be made in detail below to the preferred embodiment of the present invention as illustrated in the accompanying drawings. Also, identical reference numerals are used on different figures when substantially the same item is described.

Floor cleaning devices are popular and The Swiffer Wet Jet™ from Proctor and Gamble uses an electric battery powered sprayer to deliver cleaning or wax solutions ahead of the device. This is costly in terms of batteries and heavy/bulky. This invention can use a compressed gas cylinder to deliver the pressure for spraying liquid from the reservoir. Or, it can be made into a manual pump to replace the compressed gas cylinder. It can use a regulator to control pressure or a special sized gas cylinder with contents and pressure to match the volume of the fluid to be sprayed to avoid over-pressurization or a known propellant with an adequate vapor pressure suitable for spraying liquid. The spray control valve button or trigger can be on the reservoir, the nozzle, or remotely located on the handle. For ease of use, the nozzle can be on the reservoir or remotely located and connected by a tube or channel to the reservoir. The reservoir can be disposable or re-usable as can the other components such as the nozzle. The reservoir can be mounted at any location suitable. The spray control valve can be of any suitable design and located upstream of the nozzle. The entire system can take the form of an aerosol can to be the reservoir and propellant and valve and nozzle. The main concept is to make this product inexpensive to manufacture and inexpensive for the consumer as well as keeping things simple and easy to use.

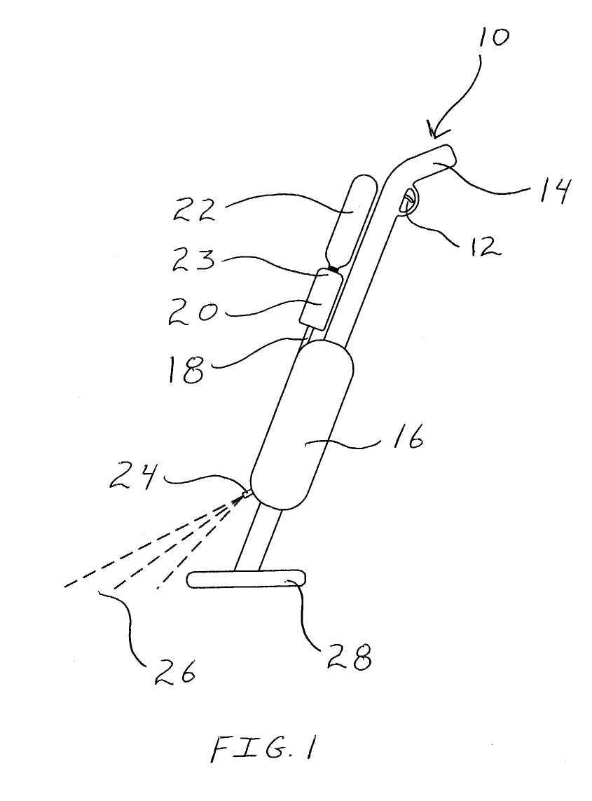

FIG. 1 shows a side view of the floor sprayer cleaning device 10 showing a compressed gas cartridge 22, optionally regulated through a pressure regulator 20, pressurizing a fluid reservoir 16. Compressed gas cartridge 22 is preferably filled with an inert gas such as carbon dioxide (CO₂) but the spirit of this application implies other gases as well. Additionally, it is intended that threaded or non-threaded compressed gas cartridges be harnessed, at at 23, as is common with many applications such as found in tire filling devices, beer keg chargers, etc. Pressure supply from cartridge 22 is fluidly connected to reservoir 16 by line 18. A user typically maneuvers cleaning device through use of handle 14. Located just below handle 14 is trigger 12 which allows the user to controllably release fluid from pressurized reservoir at discretion. Preferably, trigger 12 is mechanically connected to a biased closed spray nozzle 24 thereby allowing a simple and inexpensive link tying together both ends of the system. It is also conceivable that a cable actuation is likely as tying together both ends of the system. In a more complicated system, a servo-actuated spray nozzle is conceivable that runs on a battery operated power supply. Spray nozzle 24 sprays a spray pattern 26 preferably in front of the mopping area but it is conceivable that the liquid can run through the mop head 28 or even behind it.

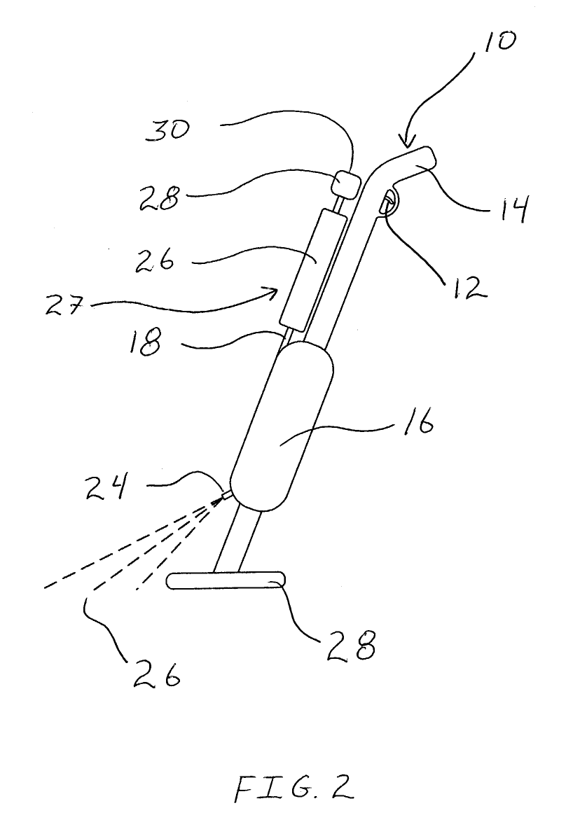

FIG. 2 shows a side view of a similar floor sprayer cleaning device 10 showing a hand-actuated pump shown at 27 with technology generally borrowed from the bicycle industry. Pump 27 comprises a cylinder 26 and pumping handle 28 for pumping the hand-actuated pump. Gauge 30 is optionally located somewhere on the pump in an easy-to-read location. It is also conceivable to incorporate a pressure-limiting valve on the reservoir thereby preventing one from over-pressurizing the fluid reservoir 16.

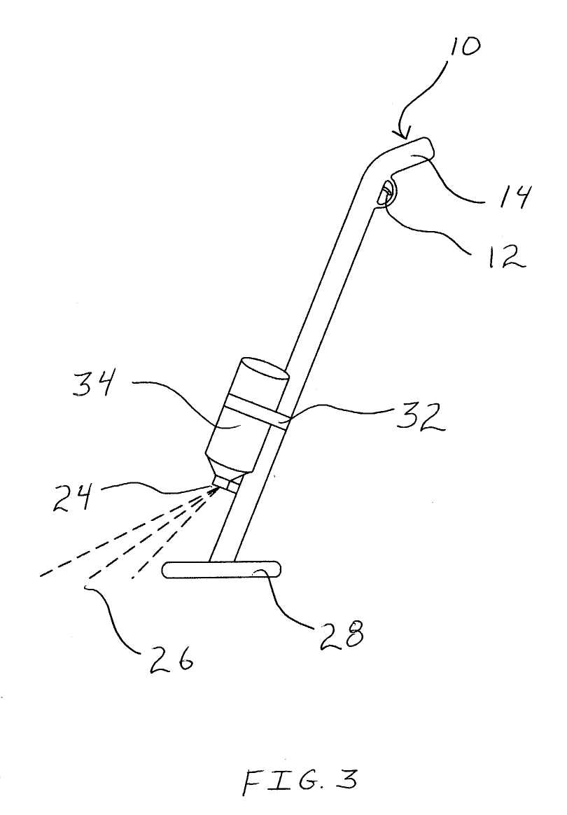

FIG. 3 shows a side view of a similar floor sprayer cleaning device 10 showing a propellant aerosol can 34. Aerosol can 34 can be a commercially available inexpensive and environmentally safe propellant providing a substantially constant pressure on a liquid reservoir (such as 16 seen in FIGS. 1 and 2). Or aerosol can 34 can contain a propellant and cleaning or wax/sealer type product all within the can so that when it runs out, a new cleaning cartridge is replaced in the cleaning device. Nozzle 24 has the option of being part of the replaceable can whereby it is replaced each time the can is replaced. Or the nozzle 24 can be permanently mounted on the cleaning device and the can plugs into the cleaning device capable of dispensing through the same nozzle for the life of the mop.

I claim:

1. A substantially mop-like floor cleaning device comprising a pressurized reservoir containing a cleaning solution; means for controllably delivering said solution at the user's discretion; at least one nozzle fluidly connected to reservoir for distributing said cleaning solution to a floor.

2. Said reservoir from claim 1 pressurized by an aerosol can fluidly connected to said reservoir.

3. Said cleaning solution from claim 1 contained in combination with propellant aerosol can.

4. Said cleaning solution reservoir from claim 1 pressurized by a fluidly-connected, hand-v actuated pump.

5. Said cleaning solution reservoir from claim 1 pressurized by a fluidly-connected compressed gas cartridge.

6. Said compressed gas cartridge of claim 5 regulated by a pressure regulator located upstream from said reservoir.

7. Said means of claim 1 for delivering said solution comprising a mechanically actuated finger trigger.

8. Said means of claim 1 for delivering said solution comprising a battery operated servo system.

9. Said hand-actuated pump of claim 4 being a piston and cylinder-type pump.

10. Said hand-actuated pump of claim 4 having a pressure-limiting valve thereby preventing over-pressurization of said cleaning solution reservoir.

11. Said device of claim 1 having a pressure gauge.
